(19) United States
(12) Patent Application Publication
(10) Pub. No.: US 2022/0058593 A1
(43) Pub. Date: Feb. 24, 2022

(54) AUTO RECONCILIATION OF BUSINESS PAYMENTS WITH BANK DATA AND THIRD-PARTY COMMISSION INVOICES

(71) Applicants: Dhaval Chokshi, South Jordan, UT (US); Viral Shah, South Jordan, UT (US)

(72) Inventors: Dhaval Chokshi, South Jordan, UT (US); Viral Shah, South Jordan, UT (US)

(21) Appl. No.: 17/406,396

(22) Filed: Aug. 19, 2021

Related U.S. Application Data
(60) Provisional application No. 63/067,763, filed on Aug. 19, 2020.

(51) Int. Cl. G06Q 20/02; G06Q 40/02

(52) U.S. Cl. CPC G06Q 20/02; G06Q 40/02

(57) ABSTRACT

A system for automatic reconciliation of business payments with bank data. The system includes a network, the network connecting the components of the system to one another. The system also includes a financial database, the financial database storing information including financial information for a business. The system further includes a business financial system, the business financial system in electronic communication with the financial database over the network and organizing the financial information for the business. The system additionally includes an automatic reconciliation tool, the automatic reconciliation tool in electronic communication with the financial database and the business financial system over the network. The automatic reconciliation tool configured to take data from a banking system, the financial database and the business financial system and automatically reconcile the data from the banking system, the financial database and the business financial system.

### CROSS-REFERENCE TO RELATED APPLICATIONS

This application claims the benefit of and priority to U.S. Provisional Patent Application Ser. No. 63/067,763 filed on Aug. 19, 2020, which application is incorporated herein by reference in its entirety.

### BACKGROUND OF THE INVENTION

Hotels have many transactions which needs to be reconciled. These transactions include financial transactions and third-party business transactions among others. For virtually every guest, there is a financial transaction as the guest has to pay for the room among other things. Each of these financial transactions has to be reconciled to payments that are deposited in the hotel's bank account.

Likewise, if a third-party helps a user to book a room, then a commission is due. However, there are a number of factors that can change the commission which is due. For example, if a guest with a reservation fails to show up to the hotel, then the booking is cancelled and no commission is due.

Hotels can have hundreds of these transactions which need to be reconciled every day. Currently, those reconciliations are done by hand. This is because reconciliation is not always a straightforward process. For example, a credit card payment will not be for a full amount of the payment made by the guest, because the credit card company will charge a merchant services fee for making the payment. Thus, the dollar amounts will not match.

Likewise, third-party systems don't always show last minute changes. Guests may change rooms, cancel all or part of a reservation, etc. Because this is not done through the third-party's software, it won't be reflected in commission reports from those third-party systems.

Currently, reconciliation is done in a spread sheet where information is placed in columns and then manually matched to one another. In many cases, the data has to be entered manually then compared to bank transactions for the day. It is a time intensive, mentally taxing process. Generally, it needs to be done regularly (usually daily) to make sure that mistakes are caught and corrected early.

Accordingly, there is a need in the art for a tool which can automatically reconcile financial transactions for a hotel. Further, there is a need in the art for a tool which can automatically reconcile third-party commissions due.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for automatic reconciliation of business payments with bank data. The system includes a network, the network connecting the components of the system to one another. The system also includes a financial database, the financial database storing information including financial information for a business. The system further includes a business financial system, the business financial system in electronic communication with the financial database over the network and organizing the financial information for the business. The system additionally includes an automatic reconciliation tool, the automatic reconciliation tool in electronic communication with the financial database and the business financial system over the network. The automatic reconciliation tool configured to take data from a banking system, the financial database and the business financial system and automatically reconcile the data from the banking system, the financial database and the business financial system.

Another example embodiment includes an automatic reconciliation system for automatic reconciliation of business financial transactions. The automatic reconciliation system including one or more hardware processors and system memory coupled to the one or more hardware processors, the system memory storing instructions that are executable by the one or more hardware processors. The one or more hardware processors executing the instructions stored in the system memory to reconcile the business financial transactions. The instructions including receiving a report from a business, where the report from the business includes a set of financial transactions and receiving a report from a bank, where the report from bank includes a set of financial transactions. The instructions also including reconciling the set of financial transactions from the business and the set of financial transactions from the bank. Reconciling the financial transactions including attempting to match each financial transaction in the set of financial transactions from the business to a financial transaction in the set of financial transactions from the bank. Reconciling the financial transactions also includes if a match is identified, marking the financial transaction in the set of financial transactions from the business as reconciled and if a match is not identified, marking the financial transaction in the set of financial transactions from the business as not reconciled. The instructions further including providing a report showing each bank transaction in the set of financial transactions from the business and each bank transaction in the set of financial transactions from the bank as reconciled or not reconciled.

Another example embodiment includes an automatic reconciliation system for automatic reconciliation of business transactions from a third-party system. The automatic reconciliation system including one or more hardware processors and system memory coupled to the one or more hardware processors, the system memory storing instructions that are executable by the one or more hardware processors. The one or more hardware processors executing the instructions stored in the system memory to reconcile the business transactions. The instructions including receiving a report from a business, where the report from the business includes a set of business transactions and receiving a report from a third-party system, where the report from third-party system includes a set of business transactions. The instructions also including reconciling the set of business transactions from the business and the set of business transactions from the third-party system. Reconciling the business transactions including attempting to match each business transaction in the set of business transactions from the business to a business transaction in the set of business transactions from the third-party system. Reconciling the business transactions also including if a match is identified, marking the business transaction in the set of business transactions from the business as reconciled and if a match is not identified, marking the business transaction in the set of business transactions from the business as not reconciled. The instructions further including providing a report showing each business transaction in the set of business transactions from the business and each business transaction in the set of business transactions from the third-party system as reconciled or not reconciled.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a block diagram illustrating an example of a system for automatic reconciliation of business payments with bank data;

FIG. 2 illustrates an automatic reconciliation tool;

FIG. 3 is an example of a deposit reconciliation dashboard;

FIG. 4 illustrates an alternative example of an automatic reconciliation tool;

FIG. 5 illustrates an example of a third-party dashboard;

FIG. 6 illustrates an example of a guest folio dashboard; and

FIG. 7 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

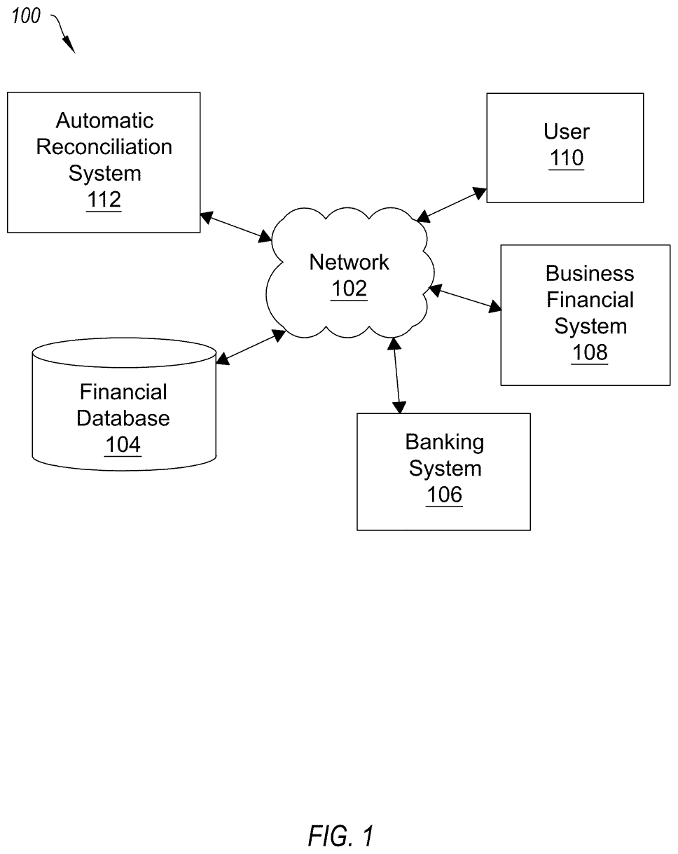

FIG. 1 is a block diagram illustrating an example of a system 100 for automatic reconciliation of business payments with bank data. In at least one implementation, the system 100 can reconcile payments marked as received by the business and deposits recorded to a bank account. While this can be done by hand for individuals or business with a low number of transactions, mistakes can be made and a large number of transactions can necessitate individuals or even departments dedicated to making sure the two match. In addition, things like credit card payments, case deposits, etc. can mean that when the payment is received and when the money is available in a bank account can vary in time quire widely. Thus, the system 100 keeps track of payments and deposit reconciliation and can flag items that need to be watched.

FIG. 1 shows that the system 100 can include a network 102. In at least one implementation, the network 102 can be used to connect the various parts of the system 100 to one another. The network 102 exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 102 includes one or more cellular RF networks and/or one or more wired and/or wireless networks such as, but not limited to, 802.xx networks, Bluetooth access points, wireless access points, IP-based networks, or the like. For example, the network 102 can include cloud-based networking and computing. The network 102 can also include servers that enable one type of network to interface with another type of network.

FIG. 1 also shows that the system 100 can include a financial database 104. In at least one implementation, the financial database 104 can include any system capable of storing and retrieving the desired financial information. For example, the financial database 104 can include an electronic database capable of electronically storing data. E.g., the financial database 104 can include memory or memory banks. Additionally or alternatively, the financial database 104 can include processors or other logic devices capable of executing software or carrying out other computer algorithms. The financial database 104 can allow a user to access the hardware of the financial database 104 for remote computing or for information retrieval.

FIG. 1 further shows that the system 100 can include a banking system 106. The banking system is a third-party banking system 106. The ability to integrate with third-party systems is critical because banks aren't going to create a system for a single vendor or even a class of vendors. Instead, banking systems 106 have standard ways that data can be accessed, and vendors are expected to then reformat the data as needed. However, banking systems 106 are very good about providing access to financial information (when proper credentials are given). Therefore, the system 100 is pulling the financial information from the banking system 106 for reconciliation.

FIG. 1 additionally shows that the system 100 can include a business financial system 108. The business financial system 108 will often, but not always, include third-party software, such as QuickBooks or other accounting software. These third-party software systems organize financial information for users. However, some larger companies have their own financial systems 108 that they have developed. Nevertheless, as in banking systems 106, most business financial systems 108 treat underlying data in similar ways. The business financial system 108 allows for entry of financial details for a business. The financial details can be imported automatically from other systems or entered manually as needed. One of skill in the art will appreciate that the financial database 104 can be integrated into the business financial system 108.

FIG. 1 moreover shows that the system 100 can include a user 110. The user 110 can include any individual, business, organization, or other entity which uses the system 100. For example, the user 110 can include hoteliers or other businesses that process multiple (hundreds or thousands) of individual financial transactions on a daily basis. The user 110 can access his/her user information in the financial database 104 over the network 102. That is, the user 110 must be authorized to have access to the system 100. The user accesses the system 100 through one or more access points and/or user interfaces, as described below.

FIG. 1 moreover shows that the system 100 can include an automatic reconciliation system 112. The automatic reconciliation system 112 takes data from the banking system 106, the financial database 104, and the business financial system 108 and compares the data. The automatic reconciliation system then presents the comparison to the user 110, indicating which data has been matched and where differences have occurred. How the differences, in particular, are presented can vary and the user 110 may have some control over those options, as described below.

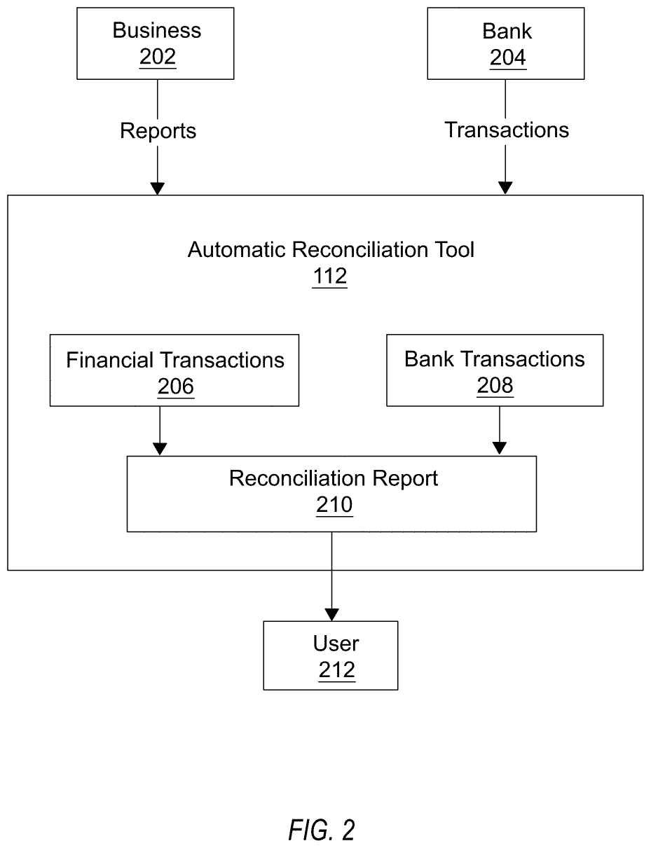

FIG. 2 illustrates an example of an automatic reconciliation system 112 which allows for automatic reconciliation of business deposits. The automatic reconciliation system 112 is software which automates the reconciliation process and will be described in relation to hoteliers but one of skill in the art will appreciate that this is for exemplary purposes only and systems and process described herein can be applied to other industries. In particular, it takes business end of day reports, automatically gathers deposit summary from the end of day reports, connects to the client's bank(s) and reconciles the deposits with each bank to ensure the funds as shown in business reports are available in each bank. The deposits include credit card batches, cash batches and check entries as well. This saves client time to reconcile the batches.

For many businesses, weekly or monthly reconciliation may be sufficient to monitor bank transactions. However, for some businesses with many transactions, such as hoteliers, daily reconciliation may be needed in order to catch any mistakes before they cause problems, particularly in cash flow.

A bank reconciliation is the process of matching the balances in an entity's accounting records for a cash account to the corresponding information on a bank statement. The goal of this process is to ascertain the differences between the two, and to book changes to the accounting records as appropriate. The information on the bank statement is the bank's record of all transactions impacting the entity's bank account during the past month.

A bank reconciliation should be completed at regular intervals for all bank accounts, to ensure that a company's cash records are correct. Otherwise, it may find that cash balances are much lower than expected, resulting in bounced checks or overdraft fees. A bank reconciliation will also detect some types of fraud after the fact; this information can be used to design better controls over the receipt and payment of cash.

At a minimum, a company should conduct a bank reconciliation shortly after the end of each month, when the bank sends the company a bank statement containing the bank's beginning cash balance, transactions during the month, and ending cash balance. For some companies, it is even better to conduct a bank reconciliation every day, based on the bank's month-to-date information, which should be accessible on the bank's web site. By completing a bank reconciliation every day, they can spot and correct problems immediately. In particular, a daily reconciliation will highlight any ACH debits from the account that were not authorized; debit block can then be installed on the account to prevent these ACH debits from being used to withdraw funds from the account without permission.

It is extremely unlikely that a company's ending cash balance and the bank's ending cash balance will be identical, since there are probably multiple payments and deposits in transit at all times, as well as bank service fees (for accepting checks, recording deposits, and so forth), penalties (usually for overdrafts), and not sufficient funds deposits that the company has not yet recorded.

The essential process flow for a bank reconciliation is to start with the bank's ending cash balance, add to it any deposits in transit from the company to the bank, subtract any checks that have not yet cleared the bank, and either add or deduct any other items. Then, go to the company's ending cash balance and deduct from it any bank service fees, NSF checks and penalties, and add to it any interest earned. At the end of this process, the adjusted bank balance should equal the company's ending adjusted cash balance.

Bank Reconciliation Terminology

The key terms to be aware of when dealing with a bank reconciliation are:

Deposit in transit. Cash and/or checks that have been received and recorded by an entity, but which have not yet been recorded in the records of the bank where the entity deposits the funds. If this occurs at month-end, the deposit will not appear in the bank statement, and so becomes a reconciling item in the bank reconciliation. A deposit in transit occurs when a deposit arrives at the bank too late for it to be recorded that day, or if the entity mails the deposit to the bank (in which case a mail float of several days can cause a delay), or the entity has not yet sent the deposit to the bank at all.

Outstanding check. A check payment that has been recorded by the issuing entity, but which has not yet cleared its bank account as a deduction from cash. If it has not yet cleared the bank by the end of the month, it does not appear on the month-end bank statement, and so is a reconciling item in the month-end bank reconciliation.

NSF check. A check that was not honored by the bank of the entity issuing the check, on the grounds that the entity's bank account does not contain sufficient funds. NSF is an acronym for “not sufficient funds.” The entity attempting to cash an NSF check may be charged a processing fee by its bank. The entity issuing an NSF check will certainly be charged a fee by its bank.

Bank Reconciliation Procedure

The following bank reconciliation procedure assumes the bank reconciliation occurs in an accounting software package, but the process by hand is similar:

Enter the bank reconciliation software module. A listing of uncleared checks and uncleared deposits will appear.

Check off in the bank reconciliation module all checks that are listed on the bank statement as having cleared the bank.

Check off in the bank reconciliation module all deposits that are listed on the bank statement as having cleared the bank.

Enter as expenses all bank charges appearing on the bank statement, and which have not already been recorded in the company's records.

Enter the ending balance on the bank statement. If the book and bank balances match, then post all changes recorded in the bank reconciliation and close the module. If the balances do not match, then continue reviewing the bank reconciliation for additional reconciling items. Look for the following items:

Checks recorded in the bank records at a different amount from what is recorded in the company's records.

Deposits recorded in the bank records at a different amount from what is recorded in the company's records.

Checks recorded in the bank records that are not recorded at all in the company's records.

Deposits recorded in the bank records that are not recorded at all in the company's records.

Inbound wire transfers from which a lifting fee has been extracted.

Bank Reconciliation Problems

There are several problems that continually arise as part of the bank reconciliation. They are:

Uncleared checks that continue to not be presented. There will be a residual number of checks that either are not presented to the bank for payment for a long time, or which are never presented for payment. In the short term, they should be treated in the same manner as any other uncleared checks—kept in the uncleared checks listing in your accounting software, so they will be an ongoing reconciling item. In the long term, the payee should be contacted to see if they ever received the check; the payor may need to void the old check and issue the payee a new one.

Checks clear the bank after having been voided. As noted in the preceding special issue, if a check remains uncleared for a long time, it may be voided and a replacement check issued. But what if the payee then cashes the original check? If voided with the bank, the bank should reject the check when it is presented. If not voided with the bank, then the check must be recorded with a credit to the cash account and a debit to indicate the reason for the payment (such as an expense account, or an increase in a cash account or decrease in a liability account). If the payee has not yet cashed the replacement check, it should be voided with the bank at once to avoid a double payment. Otherwise repayment of the second check with the payee will need to be pursued with the payee.

Deposited checks are returned. There are cases where the bank will refuse to deposit a check, usually because it is drawn on a bank account located in another country. In this case, you must reverse the original entry related to that deposit, which will be a credit to the cash account to reduce the cash balance, with a corresponding debit (increase) in the accounts receivable account.

Another possibility that may be causing problems is that the dates covered by the bank statement have changed, so that some items are included or excluded. This situation should only arise if someone at the company requested the bank to alter the closing date for the company's bank account.

Accounting software allows for manual reconciliation, but doesn't allow for automatic reconciliation. This is because accounting software has connectivity to banking systems to monitor banking transactions, but does not have connectivity to business systems to obtain deposit information and then compare to the bank feed. That is, in order to provide automatic reconciliation a connection to the business system and banking system are required.

FIG. 2 shows that the automatic reconciliation system 112 receives reports from a business 202. These reports contain information which can vary, but which will always include the financial transactions from the business 202. That is, the report will include those transactions which occurred at the business 202, but not necessarily all money transfers. For example, a credit card transaction at the business 202 is a financial transaction as recorded by the business but there may be a delay of several business days before the money from the transaction is actually deposited.

FIG. 2 also shows that the automatic reconciliation system 112 receives reports from a bank 204. The bank 204 is anyplace that is holding monetary assets for the business 202. Thus, one of skill in the art will appreciate that “bank” as used herein can include more than one financial institution, not all of which are actually banks. For example, the bank 204 could be an investment firm or other entity which holds assets but doesn't qualify as a bank or a third-party vendor system that holds monies for the business 202.

As shown in FIG. 2, the automatic reconciliation tool 112 must then breakdown the information received from the business 202 and the bank 204. This is a two-step process. First, information from the business 202 is analyzed to create a list of financial transactions 206 and the information from the bank 204 is analyzed to create a list of bank transactions 208. Second, the financial transactions 206 and the bank transaction 208 need to be placed in a format where the two can be compared. For example, a spreadsheet and text document cannot be automatically compared to one another; however, if the spreadsheet is converted to text, then direct comparisons are possible. One of skill in the art will appreciate that these steps need not be in a particular order and may be combined.

FIG. 2 further shows that the automatic reconciliation tool 112 undergoes a reconciliation process to create a reconciliation report 210. The reconciliation report 210 is a comparison of the financial transaction 206 and the bank transactions 208 noting matches and differences. One of skill in the art will appreciate that reconciliation will not normally be a straightforward process where the first financial transaction 206 matches the first bank transaction 208, the second financial transaction 206 matches the second bank transaction 208, etc. Instead, the process is likely to be messy with lots of issues that may cause confusion. For example, it is possible, and in some businesses probable, that none of the financial transactions 206 for a single day match the bank transactions 208 for that day (cash and checks are deposited after bank closing, credit cards payments not deposited, bank transfers not occurring until the following business day, etc.).

In addition, some financial transactions 206 may be for the same amount as one another (which may lead to eventual bank transactions 208 being the same as one another). For example, if a hotel has 100 rooms for rent and they are all for the same price, then that hotel is likely to have many financial transactions 206 that are the exact same (some will vary due to extra charges, etc.). Thus, other identifiers, such as transaction id, may need to be compared to properly reconcile. Likewise, deposits of cash may be done lump sum (as are payments from merchant services companies). Thus, one bank transaction 208 can include multiple financial transaction 206 spread out over multiple days and multiple parts of days. All of this means that reconciliation must be done in a way that it is clear which financial transaction 206 matches which bank transaction 208 and vice versa.

FIG. 2 additionally shows that the automatic reconciliation tool 112 the presents the reconciliation report 210 to a user 212. The user 212 needs to be able to see which deposits have been reconciled and which might need further information for reconciliation. In addition, some guidance from the user 212 may be needed for the reconciliation to proceed. I.e., if the automatic reconciliation tool 112 is unable to determine which financial transaction 206 to match to a particular bank transaction 208 a user 212 may need to provide additional information or guidance to ensure correctness of the reconciliation. One of skill in the art will appreciate that this can be presented to the user 212 as options. For example, the automatic reconciliation tool 112 can ask the user 212 to select one of two possible financial transactions 206 to match to a bank transaction 208.

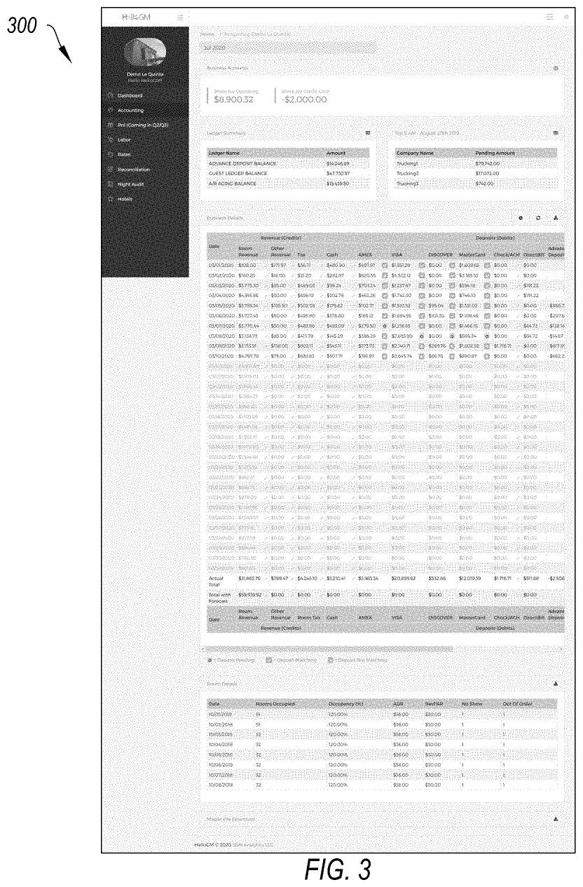

FIG. 3 illustrates an example of a bank deposit dashboard 300 as shown to a user. FIG. 3 shows that the dashboard 300 shows a complete picture to the user. In particular, because the bank transactions and financial transaction rarely sync in time with one another, it can be difficult for a business to know how much cash is on hand and how much to expect in coming days. However, the dashboard can present this information to the user, allowing him/her to make informed financial decisions. E.g., if an invoice is due the dashboard 300 allows the user to not only see if funds are available to pay the invoice but which funds will be available in the coming days. The user can also determine how likely those funds are to actually arrive as usable funds. For example, not all deposited checks will clear, so those deposits are less reliable, cash payments are already in hand so those are available as soon as deposit happens, and credit card payments are highly likely to actually be deposited but are delayed in time and area subject to some service fees. Thus, the user can not only see past and present financial conditions but make projections about fund availability for the near future.

FIG. 3 shows the transactions that have been successfully completed by the automatic reconciliation tool (green), those that need user attention (yellow), and those that aren't reconcilable (red). Transactions that are marked in yellow and red aren't necessarily unreconcilable, they may just need more information to be reconciled. For example, if two transactions are the same dollar amount, then the reconciliation tool may need guidance as to which should be reconciled where. In addition, some transactions may take place after banking hours, meaning they don't show on the bank feed until the next day. I.e., they will automatically be reconciled the following business day. Likewise, those transactions may have just occurred in one place but not another. For example, the item from March 7 which is yellow will likely be green on the next day report as the AMEX deposit occurs and reconciliation is achieved. Likewise, the item in the AMEX column for March 8 marked in red will likely turn green in coming day. However, when items are left as yellow or red for multiple days or beyond the point when they are typically resolved, the yellow and red flags alert the user to the problem.

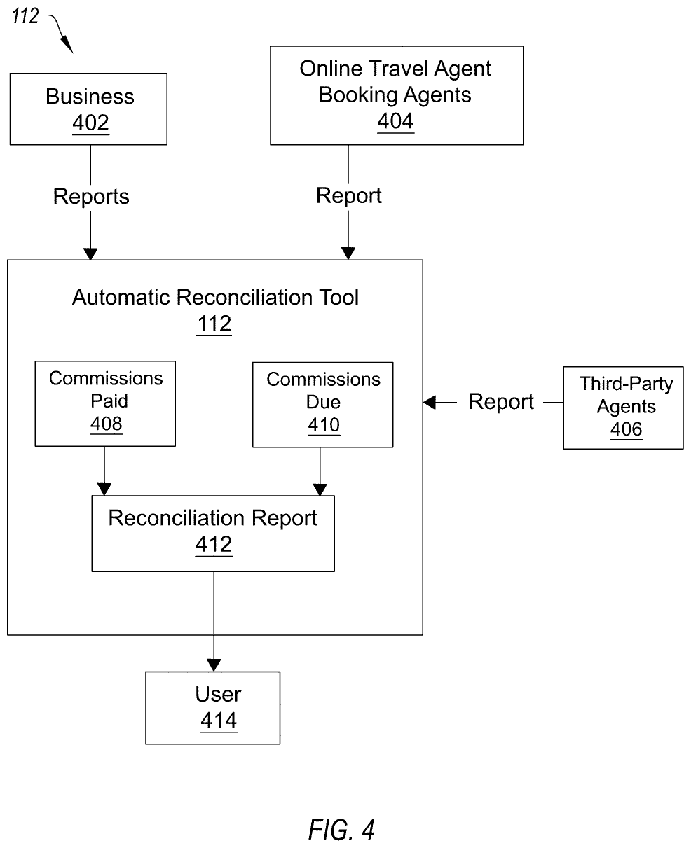

FIG. 4 illustrates an alternative example of an automatic reconciliation system 112 which reconciles transactions from third-party systems. One of skill in the art will appreciate that a single automatic reconciliation system 112 can include the functionality described above in relation to FIG. 2 and the functionality described below. Many businesses rely on agents (like travel agent offices or online travel agents) to sell their services. For example, hotels rely on multiple sources to get rooms booked including a network of traditional travel agents as well as online travel agents like Expedia.com, Hotels.com, Booking.com, etc. which receive a commission based on factors, such as rooms rented. These agents then provide invoices to the business monthly for commissions earned. Without automation, businesses must reconcile these invoices manually by checking each transaction. The automatic reconciliation tool 112 automates this reconciliation process by automatically gathering business data and comparing that with third-party commission invoices. Any difference identified is presented to the user.

FIG. 4 shows that the automatic reconciliation system 112 receives reports from a business 402. These reports contain information which can vary, but which will always include the bookings from third-party vendors from the business 402. That is, the report will include those bookings which occurred at the business 402 by third-party vendors, but not necessarily all bookings. The report will also include information on the commissions due and/or the information required to calculate said commissions.

FIG. 4 also shows that the automatic reconciliation system 112 receives reports from online travel agent booking agents 404. This are typically websites, which allow a user to make a reservation by comparing hotels given certain search parameters. In return, these online travel agent booking agents 404 receive a commission that is paid monthly.

FIG. 4 further shows that the automatic reconciliation system 112 receives reports from third-party agents 406. These third-party agents 406, such as travel agents perform a similar role as the online travel agent booking agents 404, but commissions may work differently. Many of these third-party agents 406 don't deal with one hotel enough that they need to delay commissions. Thus, commissions are typically handled one at a time rather than in a batch (such as monthly).

As shown in FIG. 4, the automatic reconciliation tool 112 must then breakdown the information received from the business 402, online travel agent booking agents 404, and third-party agents 406. This is a two-step process. First, information from the business 202 is analyzed to create a list of commissions paid 408 and the information from the online travel agent booking agents 404, and third-party agents 406 is analyzed to create a list of commissions due 410. Second, the commissions paid 408 and the commissions due 410 need to be placed in a format where the two can be compared. One of skill in the art will appreciate that these steps need not be in a particular order and may be combined.

FIG. 4 further shows that the automatic reconciliation tool 112 undergoes a reconciliation process to create a reconciliation report 412. The reconciliation report 412 is a comparison of the commissions paid 408 and the commissions due 410 noting matches and differences. One of skill in the art will appreciate that reconciliation will not normally be a straightforward process where the first commission paid 408 matches the first commission due 410, the second commission paid 408 matches the second commission due 410, etc. Instead, the process is likely to be messy with lots of issues that may cause confusion. For example, it is possible, and in some businesses probable, that commissions due 410 are received the same day that they are paid. Instead, there is often a delay before the actual monetary exchange occurs.

In addition, some commissions due 410 may be for the same amount as one another (which may lead to eventual commissions paid 408 being the same as one another). For example, if a hotel has 100 rooms for rent and they are all for the same price, then that hotel is likely to have many commissions due 408 that are the exact same (some will vary due to extra charges, etc.). Thus, other identifiers, such as transaction id, may need to be compared to properly reconcile. In addition, one commission paid 408 can include multiple commissions due 410. All of this means that reconciliation must be done in a way that it is clear which commission paid 408 matches commission due 410 and vice versa.

FIG. 2 additionally shows that the automatic reconciliation tool 112 the presents the reconciliation report 412 to a user 414. The user 414 needs to be able to see which commissions have been reconciled and which might need further information for reconciliation. In addition, some guidance from the user 414 may be needed for the reconciliation to proceed. I.e., if the automatic reconciliation tool 112 is unable to determine which commission due 410 to match to a particular commission paid 408 a user 414 may need to provide additional information or guidance to ensure correctness of the reconciliation. One of skill in the art will appreciate that this can be presented to the user 414 as options. For example, the automatic reconciliation tool 112 can ask the user 414 to select one of two possible commissions due 410 to match to a commission paid 408.

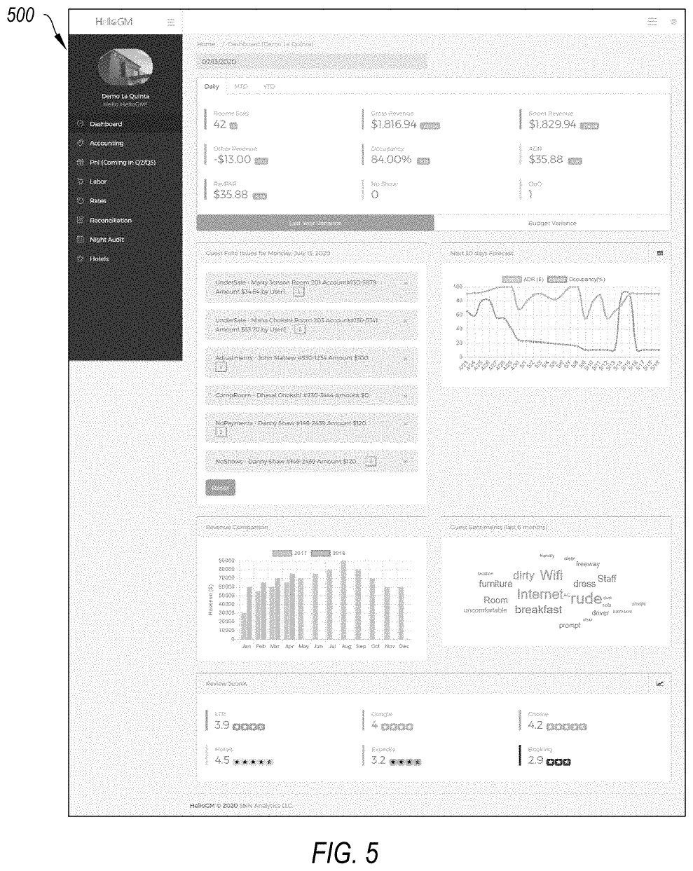

FIG. 5 illustrates an example of a third-party dashboard 500. The third-party dashboard 500 allows hotels to confirm payments that should be made to third-party vendors. In particular, third-party vendors, such as Booking.com, Expedia and others charge hoteliers for commissions based on rooms they sent to the hotels; however, cancellations, no shows, extended stays or shortened stays can change the amount that is actually owed. That is, a third-party vendor may show that a certain amount of commission is due based on bookings, but commissions should only be paid on actual stays. The automatic reconciliation system 112 automatically detect issues related to over payment of commissions and saves money for hoteliers.

FIG. 5 shows that the third-party dashboard 500 allows a hotelier to review the commissions that are coming due and confirm whether the commissions being charged match the commissions that should be paid. The transactions which match between the third-party vendor and the internal business systems are marked in green, transactions that need to be reviewed are marked in red, along with a reason that review is needed. Therefore, the hotelier can be sure that the commissions being paid are accurate.

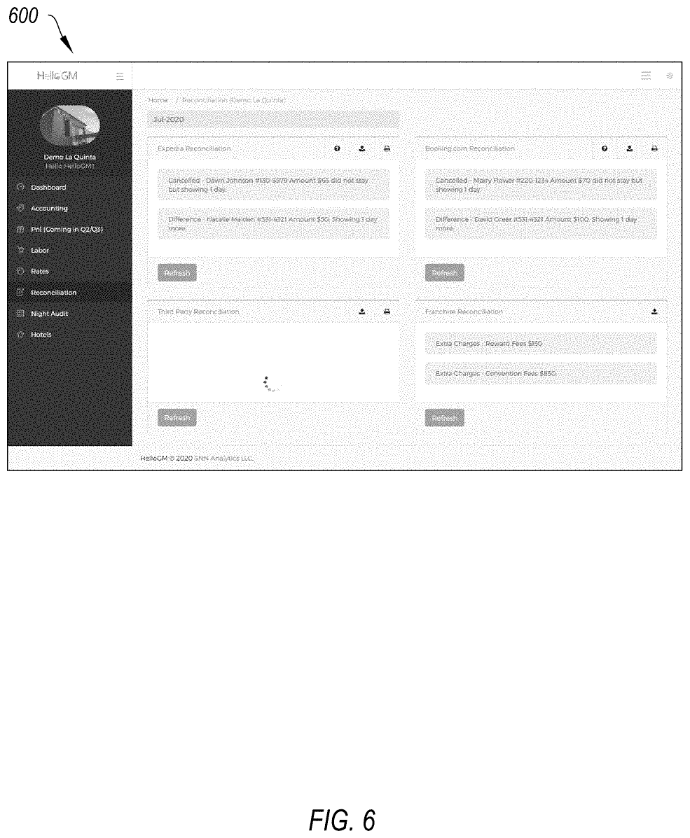

FIG. 6 illustrates an example of a guest folio dashboard 600. The guest folio dashboard 600 allows a hotelier to see if there are errors in guest folios, such as adjustments needed, non-payments, under-payments, etc. In particular, the dashboard 600 allows a hotelier to see if there is any error that needs to be corrected. For example, if a guest stays in a room and extends his/her stay, the guest folio dashboard 600 can show that the payment amount doesn't match the amount that should have been paid for the stay, which can then be charged to ensure proper payment.

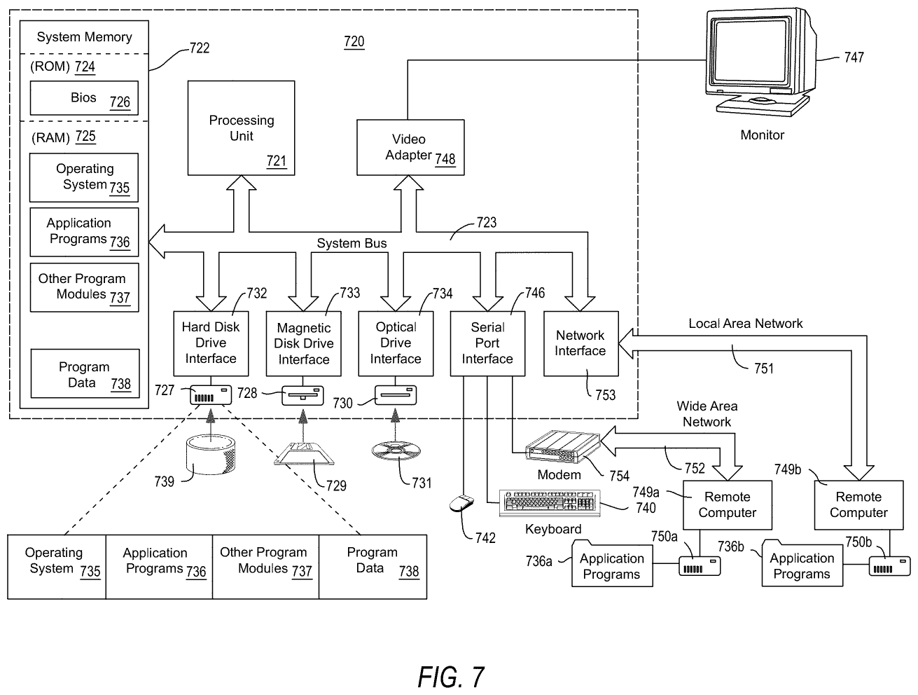

FIG. 7, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 7, an example system for implementing the invention includes a general purpose computing device in the form of a conventional computer 720, including a processing unit 721, a system memory 722, and a system bus 723 that couples various system components including the system memory 722 to the processing unit 721. It should be noted however, that as mobile phones become more sophisticated, mobile phones are beginning to incorporate many of the components illustrated for conventional computer 720. Accordingly, with relatively minor adjustments, mostly with respect to input/output devices, the description of conventional computer 720 applies equally to mobile phones. The system bus 723 may be any of several types of bus structures including a memory bus or memory controller, a peripheral bus, and a local bus using any of a variety of bus architectures. The system memory includes read only memory (ROM) 724 and random access memory (RAM) 725. A basic input/output system (BIOS) 726, containing the basic routines that help transfer information between elements within the computer 720, such as during start-up, may be stored in ROM 724.

The computer 720 may also include a magnetic hard disk drive 727 for reading from and writing to a magnetic hard disk 739, a magnetic disk drive 728 for reading from or writing to a removable magnetic disk 729, and an optical disc drive 730 for reading from or writing to removable optical disc 731 such as a CD-ROM or other optical media. The magnetic hard disk drive 727, magnetic disk drive 728, and optical disc drive 730 are connected to the system bus 723 by a hard disk drive interface 732, a magnetic disk drive-interface 733, and an optical drive interface 734, respectively. The drives and their associated computer-readable media provide nonvolatile storage of computer-executable instructions, data structures, program modules and other data for the computer 720. Although the exemplary environment described herein employs a magnetic hard disk 739, a removable magnetic disk 729 and a removable optical disc 731, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 739, magnetic disk 729, optical disc 731, ROM 724 or RAM 725, including an operating system 735, one or more application programs 736, other program modules 737, and program data 738. A user may enter commands and information into the computer 720 through keyboard 740, pointing device 742, or other input devices (not shown), such as a microphone, joy stick, game pad, satellite dish, scanner, motion detectors or the like. These and other input devices are often connected to the processing unit 721 through a serial port interface 746 coupled to system bus 723. Alternatively, the input devices may be connected by other interfaces, such as a parallel port, a game port or a universal serial bus (USB). A monitor 747 or another display device is also connected to system bus 723 via an interface, such as video adapter 748. In addition to the monitor, personal computers typically include other peripheral output devices (not shown), such as speakers and printers.

The computer 720 may operate in a networked environment using logical connections to one or more remote computers, such as remote computers 749a and 749b. Remote computers 749a and 749b may each be another personal computer, a server, a router, a network PC, a peer device or other common network node, and typically include many or all of the elements described above relative to the computer 720, although only memory storage devices 750a and 750b and their associated application programs 736a and 736b have been illustrated in FIG. 7. The logical connections depicted in FIG. 7 include a local area network (LAN) 751 and a wide area network (WAN) 752 that are presented here by way of example and not limitation. Such networking environments are commonplace in office-wide or enterprise-wide computer networks, intranets and the Internet.

When used in a LAN networking environment, the computer 720 can be connected to the local network 751 through a network interface or adapter 753. When used in a WAN networking environment, the computer 720 may include a modem 754, a wireless link, or other means for establishing communications over the wide area network 752, such as the Internet. The modem 754, which may be internal or external, is connected to the system bus 723 via the serial port interface 746. In a networked environment, program modules depicted relative to the computer 720, or portions thereof, may be stored in the remote memory storage device. It will be appreciated that the network connections shown are exemplary and other means of establishing communications over wide area network 752 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for automatic reconciliation of business payments with bank data, the system comprising:
a network, the network connecting the components of the system to one another;
a financial database, the financial database storing information including:
financial information for a business; and
a business financial system, the business financial system:
in electronic communication with the financial database over the network; and
organizing the financial information for the business; and
an automatic reconciliation tool, the automatic reconciliation tool:
in electronic communication with the financial database over the network;
in electronic communication with the business financial system over the network; and
configured to take data from a banking system, the financial database and the business financial system;
automatically reconcile the data from the banking system, the financial database and the business financial system.

2. The system of claim 1, wherein the network includes the Internet.

3. The system of claim 1 wherein:
the automatic reconciliation system outputs a report to a user.

4. The system of claim 3, wherein the report indicates which data has been reconciled.

5. The system of claim 3, wherein the report indicates which data has not been reconciled.

6. An automatic reconciliation system for automatic reconciliation of business financial transactions, the automatic reconciliation system comprising:
one or more hardware processors;
system memory coupled to the one or more hardware processors, the system memory storing instructions that are executable by the one or more hardware processors;
the one or more hardware processors executing the instructions stored in the system memory to reconcile the business financial transactions, including the following:
receive a report from a business, wherein the report from the business includes a set of financial transactions;
receive a report from a bank, wherein the report from bank includes a set of financial transactions;
reconcile the set of financial transactions from the business and the set of financial transactions from the bank including:
attempting to match each financial transaction in the set of financial transactions from the business to a financial transaction in the set of financial transactions from the bank;
if a match is identified, marking the financial transaction in the set of financial transactions from the business as reconciled;
if a match is not identified, marking the financial transaction in the set of financial transactions from the business as not reconciled;
providing a report showing each bank transaction in the set of financial transactions from the business and each bank transaction in the set of financial transactions from the bank as reconciled or not reconciled.

7. The system of claim 6, wherein one financial transaction in the set of financial transactions from the business is matched to multiple financial transactions in the set of financial transactions from the bank.

8. The system of claim 6, wherein multiple financial transactions in the set of financial transactions from the business are matched to one financial transaction in the set of financial transactions from the bank.

9. The system of claim 6, wherein the reconciled financial transactions are shown in the report as green.

10. The system of claim 9, wherein the not reconciled financial transactions are shown in the report as red.

11. The system of claim 6 further comprising:
marking one or more of the financial transactions in the set of financial transactions from the business marked as not reconciled as pending.

12. The system of claim 11, wherein the pending financial transactions are shown in the report as yellow.

13. The system of claim 6, wherein receiving a report from a business includes reformatting the data in the report.

14. The system of claim 6, wherein receiving a report from a bank includes reformatting the data in the report.

15. The system of claim 6, wherein the report includes information on one or more financial transactions from the set of financial transactions from the business which requires more information from the user.

16. An automatic reconciliation system for automatic reconciliation of business transactions from a third-party system, the automatic reconciliation system comprising:
one or more hardware processors;
system memory coupled to the one or more hardware processors, the system memory storing instructions that are executable by the one or more hardware processors;
the one or more hardware processors executing the instructions stored in the system memory to reconcile the business transactions, including the following:
receive a report from a business, wherein the report from the business includes a set of business transactions;
receive a report from a third-party system, wherein the report from third-party system includes a set of business transactions;
reconcile the set of business transactions from the business and the set of business transactions from the third-party system including:
attempting to match each business transaction in the set of business transactions from the business to a business transaction in the set of business transactions from the third-party system;
if a match is identified, marking the business transaction in the set of business transactions from the business as reconciled;
if a match is not identified, marking the business transaction in the set of business transactions from the business as not reconciled;
providing a report showing each business transaction in the set of business transactions from the business and each business transaction in the set of business transactions from the third-party system as reconciled or not reconciled.

17. The system of claim 16, wherein each business transaction is a commission for a hotel booking.

18. The system of claim 16, wherein the third-party system is an online travel agency booking agent.

19. The system of claim 16, wherein the third-party system is a travel agent.
